(19) United States
(12) Patent Application Publication
(10) Pub. No.: US 2020/0205437 A1
(43) Pub. Date: Jul. 2, 2020

(54) COATED STUFFED PRETZEL AND METHOD OF MAKING A COATED STUFFED PRETZEL FROM AN ALREADY BAKED PRETZEL

(71) Applicant: Lawrence R. Szrama, Elma, NY (US)

(72) Inventor: Lawrence R. Szrama, Elma, NY (US)

(21) Appl. No.: 16/814,499

(22) Filed: Mar. 10, 2020

Related U.S. Application Data
(63) Continuation of application No. 16/250,021, filed on Jan. 17, 2019.
Application No. 16/250,021 is a division of application No. 14/935,720, filed on Nov. 9, 2015, now abandoned.
(60) Provisional application No. 62/222,493, filed on Sep. 23, 2015.

(51) Int. Cl. A23G 1/30; A23G 1/50; A23G 1/54; A21D 13/38; A21D 13/24; A21D 13/32; A21D 13/28; A23G 3/34; A23G 3/20

(52) U.S. Cl. CPC A23G 1/305; A23G 1/507; A23G 1/54; A21D 13/38; A23G 3/203; A21D 13/32; A21D 13/28; A23G 3/0072; A21D 13/24

(57) ABSTRACT

A coated stuffed pretzel and method for making the coated stuffed pretzel is provided. A pretzel that has already been baked has first, second and third pretzel openings. A layer of chocolate is deposited in the first and second openings pretzel openings, then a filling and chocolate is deposited on the layer of chocolate, thus stuffing the first and second pretzel openings. The pretzel is cooled and then is moved through a chocolate bath where an outer chocolate layer is applied. Then, toppings are added on the chocolate coating. The pretzel is cooled and the toppings are held in place when the chocolate outer layer solidifies. Thus, the pretzel that has already been baked is transformed into the coated stuffed pretzel. The coated stuffed pretzels can be coated with any topping and stuffed with any filling, for example caramel. The coated stuffed pretzels have a handle portion.

### CROSS REFERENCE TO RELATED APPLICATION

This application is a continuation of U.S. patent application Ser. No. 16/250,021, filed on Jan. 17, 2019, which is a divisional of U.S. patent application No. 14/935,720, filed on Nov. 9, 2015, which claims priority to U.S. Provisional Application having Ser. No. 62/222,493, filed on Sep. 23, 2015, the entire disclosure of which is hereby incorporated herein by reference.

### FIELD OF INVENTION

This invention is directed to a method for making coated stuffed pretzels from already baked pretzels.

### BACKGROUND OF INVENTION

People enjoy eating pretzels for a variety of reasons. Many people find the taste and texture of pretzels to be quite enjoyable, especially when paired with certain foods, dips and drinks. People also dip or coat their pretzels in chocolate to enhance the culinary experience of eating pretzels. However, to date dipping pretzels in or coating them with chocolate provides the highest level of culinary pleasure that can be obtained from a pretzel. The common practice of coating pretzels in chocolate has made chocolate coated pretzels quite ordinary, meaning the consumer does not expect and does not receive a new culinary experience while eating these pretzels.

There are also pretzels that have cores of filling. For example, some pretzels are formed by laying down a sheet of dough, depositing filling on the dough, and rolling up the pretzel in the shape of a tube and baking the pretzel. The result is a pretzel nugget that has a very hard outer shell with a dry filling. This is because the moisture in the filling evaporates during the baking process. However, these stuffed pretzels fail to provide an enjoyable or memorable culinary experience due to their hardness, texture and taste.

Thus, there is a need for a pretzel that enhances the culinary experience of the consumer and that comes in different flavored fillings, and there is a need for an assembly that is capable of making such pretzels.

### SUMMARY OF THE INVENTION

A pretzel that has already been baked is stuffed fillings and coated with chocolate, thus transforming the ordinary pretzel into a unique and delicious edible product.

Molds are made to hold the pretzels that are already baked. In particular there is a vacuum forming machine that makes pretzel molds for holding the pretzels, such that the pretzel molds define pretzel mold recesses The pretzels have first, second and third pretzel openings and the pretzels are placed in the pretzel mold. The pretzel mold is placed on a conveyor that transports the pretzel mold and pretzels disposed therein to a one shot pretzel filling station wherein the first and second pretzel opening are filled. In particular, first a layer of chocolate is deposited in the first and second pretzel openings. This is followed by simultaneously depositing more chocolate and a filling in the pretzel openings, such that the filling is surrounded by or encased in chocolate. The filling is liquid caramel one of the preferred embodiments and completely encased in chocolate.

After the first and second pretzel openings are filled in this manner, the pretzel mold and the pretzels supported therein are cooled in a cooling tunnel. The liquid caramel filling is still liquid after exiting the cooling tunnel in one of the preferred embodiments, that is, it is still liquid after cooling. After exiting the cooling tunnel the pretzels are removed from the pretzel molds and are placed on a wire conveyor and moved to a chocolate coating machine or chocolate bath where the pretzels are coated in chocolate. Then, toppings are deposited on the pretzels, for example nuts, candy, candy pieces, chocolate flakes having different colors and the like without limitation, and more chocolate drizzle can be poured over the pretzels. The coated stuffed pretzels have thus been created and need to be cooled. Thus, the coated stuffed pretzels are transported on the wire conveyor back through the cooling tunnel and upon exiting the cooling tunnel are packaged.

The pretzels have a third pretzel opening that is defined in part by a handle portion of the pretzel that was not filled. That is, the third pretzel opening was not stuffed, meaning the consumer can use the handle portion of the pretzel to grip the coated stuffed pretzel. In other preferred embodiments the third pretzel opening is also filled and coated in manner described above, or only one of the first, second and third pretzel openings is filled and coated in the manner described above.

### BRIEF DESCRIPTION OF THE DRAWINGS

FIG. 1 is top view of an already baked pretzel.

FIG. 2 is a top view of a plastic sheet.

FIG. 3 is a perspective view of a die plate.

FIG. 4 is a front view of a vacuum forming machine wherein the plastic sheet is disposed in the vacuum forming machine on top of the die plate.

FIG. 5 perspective view of the pretzel mold created in the vacuum forming machine.

FIG. 6 is an enlarged perspective view of a portion of the pretzel mold.

FIG. 7 is an enlarged perspective view of a portion of the pretzel mold wherein a pretzel that has already been baked is disposed in the pretzel mold.

FIG. 8 is an enlarged top view of a portion of the pretzel mold wherein the pretzel that has already been baked is disposed in the pretzel mold.

FIG. 9 an elevated perspective view of the pretzel mold with three pretzels disposed therein.

FIG. 10 is a sectional view of a one shot pretzel filling machine and conveyor for transporting pretzel molds filled with pretzels, and FIG. 10 is continued in FIG. 16.

FIG. 11 is a perspective view of a one-shot dispenser head.

FIG. 12 is a front view of a dispensing head and dispensers positioned over the pretzel mold with pretzels disposed in the pretzel mold.

FIG. 13 is a top view of a portion of the pretzel mold after a layer of chocolate has been deposited in first and second pretzel openings defined in the pretzel.

FIG. 14 is a top view of the pretzel after the first and second pretzel openings have been stuffed with a filling and coated and encased in chocolate.

FIG. 15 is a sectional view of the pretzel of FIG. 14 taken along cut line A-A of FIG. 14 and shows the filling encased in chocolate.

FIG. 15A is a sectional view of the pretzel of FIG. 14 taken along cut line A-A of FIG. 14 and shows the filling that is in the form of pieces or particles.

FIG. 16 is a continuation of the assembly line shown in FIG. 10.

FIG. 17 is a top view of the coated stuffed pretzel after cooling.

FIG. 18 is a sectional view of the coated stuffed pretzel taken along line B-B of FIG. 17.

### DETAILED DESCRIPTION

As shown in FIG. 1 there is a pretzel 20 that is already fully baked. The pretzel 20 has an outer pretzel surface 22. The pretzel 20 has salt 24 in the form of crystals, chips or grains that are supported on and baked in to the outer pretzel surface 22. In other preferred embodiments the salt 24 is not present, that is, the pretzel 20 is unsalted.

The pretzel 20 has a first surrounding pretzel wall 28 that defines a first pretzel opening 30, and the pretzel 20 has a second surrounding pretzel wall 32 that defines a second pretzel opening 34, and the pretzel 20 has a third surrounding wall 36 that defines a third pretzel opening 38. The pretzel 20 has a cross portion 40 from which extends a first arm portion 42 and a first curved portion 44. The first arm portion 42 extends to and merges with the first curved portion 44 at a first junction portion 45. Also extending from the cross portion 40 is a second arm portion 46 and a second curved portion 48. The second arm portion 46 extends to and merges with the second curved portion 48 at a second junction portion 47. The pretzel 20 also has a handle portion 50 that extends to and merges with the first junction portion 45, and the handle portion 50 extends to and merges with the second junction portion 47.

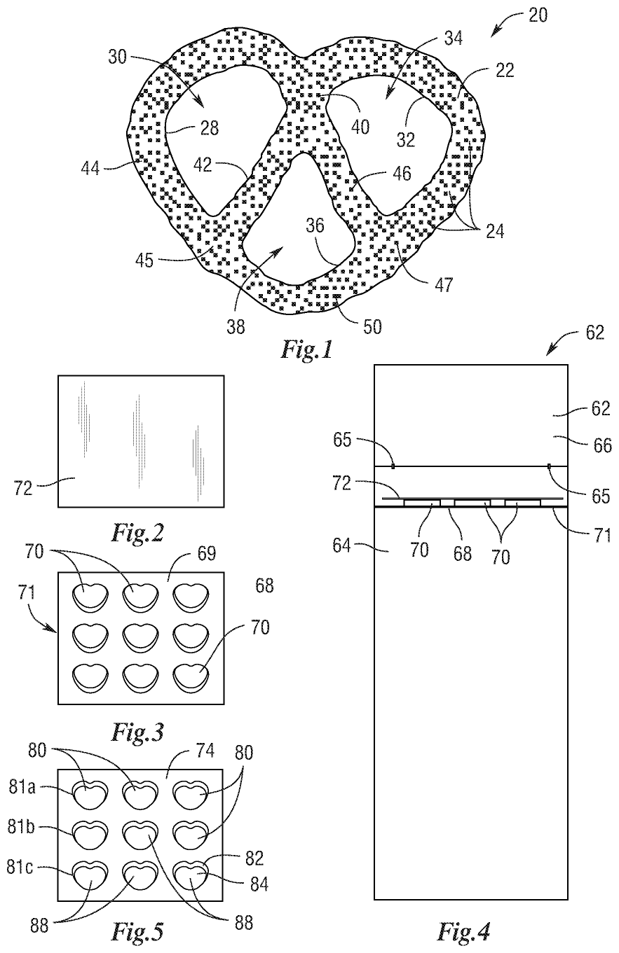

FIG. 4 shows a vacuum forming machine 62 that is used to make pretzel molds 74. The vacuum forming machine 62 has a body portion 64 and hinges 65 connect a lid 66 to the body portion 64. Internal to the vacuum forming machine 62 are heating components (not shown) and negative pressure generating components (not shown). Vacuum forming machines are well known to those having ordinary skill in the art and are therefore not described in greater detail herein. Disposed internal to the vacuum forming machine 62 is a male die plate 68 (FIG. 3) having opposed first and second die plate sides 69, 71. At least one male die member 70 extends from the first side 69 of the die plate 68. FIG. 3 is a perspective view of the male die plate 68 showing nine male die members 70 extending from the first die plate side 69 arranged in a three by three array. In other referred embodiments there may be more or less than nine male die members 70. It is pointed out that the male die members 70 mimic the shape of the pretzel 20, but the male die members 70 are dimensional larger than the pretzel 20 in one of the preferred embodiments as will be described presently. A plastic sheet 72 is shown in FIG. 2 and the plastic sheet 72 is placed over the male die members 70 as shown in FIG. 4. When the vacuum forming machine 62 is turned on or activated on the plastic sheet 72 heated and a vacuum is generated internal to the vacuum forming machine 62. This causes the plastic sheet 72 to deform and press against the male die members 70 and take on the shape of the male die members 70. After vacuum forming is completed, the plastic sheet 72 has been transformed into a pretzel mold 74 as shown in FIG. 5.

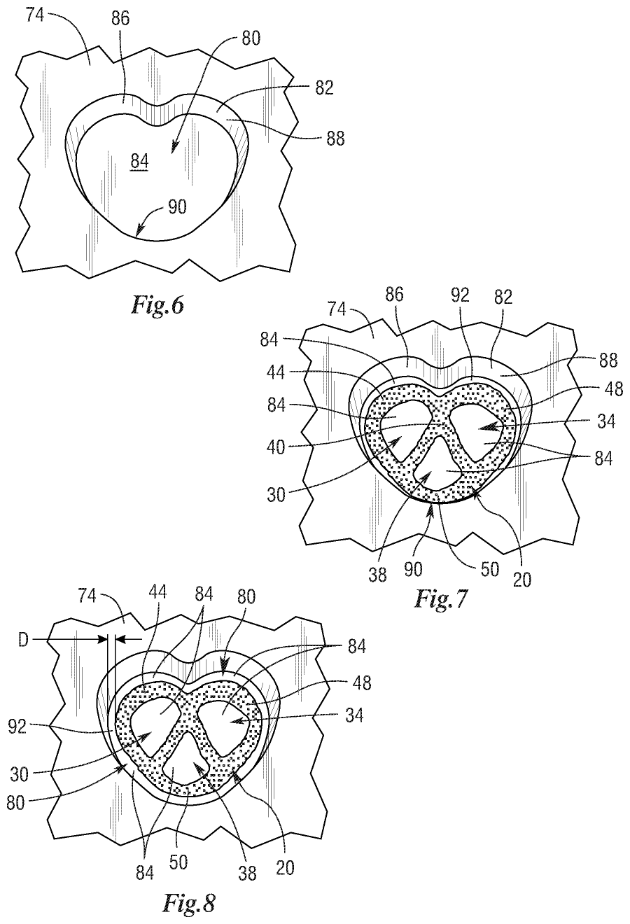

FIG. 5 shows that the pretzel mold 74 defines nine pretzel mold recesses 80 that have the same shape and that are arrange in a three by three array. FIG. 6 is an enlarged view of a portion of the pretzel mold 74 showing one of the pretzel mold recesses 80. Each pretzel mold recess 80 is defined by surrounding mold wall 82 that extends to a mold base wall 84. The surrounding mold wall 82 has first and second curved surrounding wall portions 86, 88 that meet with one another. The surrounding mold wall 82 also has a handle surrounding wall portion 90 that extends to each of the first and second curved surrounding wall portions 86, 88. As shown in FIG. 5, the pretzel mold 74 is shaped such that there are first, second and third rows 81a, 81b, and 81c of pretzel mold recesses with three pretzel mold recesses 80 in each row. It is to be understood that in other preferred embodiments the pretzel mold 74 can be made to have a single pretzel mold recess 80, or more than one pretzel mold recess 80, for example twelve pretzel mold recesses 80.

FIG. 7 is the perspective view of FIG. 6 wherein a pretzel 20 is positioned in the pretzel mold recess 80 and the pretzel 20 is supported on the mold base wall 84. In particular, the pretzel 20 is situated such that the first curved portion 44 of the pretzel 20 is aligned with and faces the first curved surrounding wall portion 86. Similarly, the second curved portion 46 of the pretzel 20 is aligned with and faces the second curved surrounding wall portion 88. The handle portion 50 of the pretzel 20 is aligned with and faces the handle surrounding wall portion 90 of the surrounding mold wall 82. It is pointed out that in one of the preferred embodiments the surrounding mold wall 82 does not contact the pretzel 20, but in other preferred embodiments it does make contact.

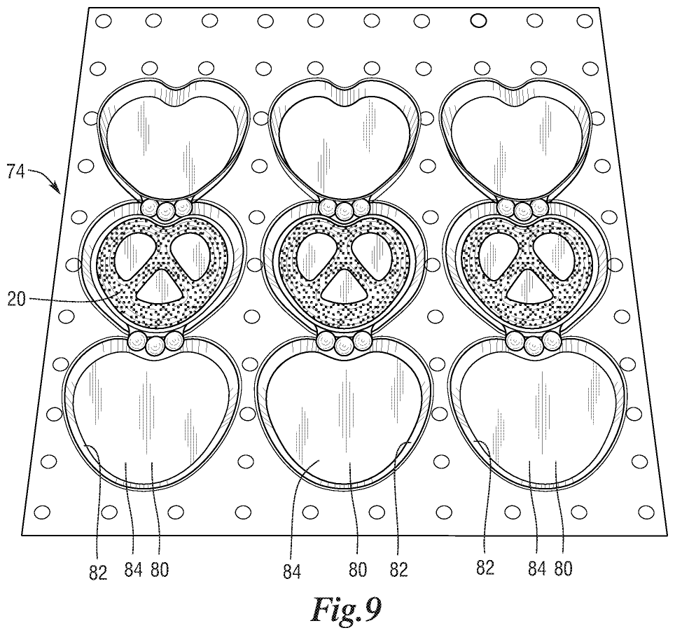

In particular, as shown in FIG. 8 a gap space 92 exists and extends from the surrounding mold wall 82 to the pretzel 20, such that the first curved portion 44, the second curved portion 48 and handle portion 50 of the pretzel 20 do not contact the surrounding mold wall 82. The reference letter D in FIG. 8 designates the gap space 92 that is defined as the distance from the surrounding mold wall 82 to the pretzel 20. The gap space is about 0.25 inches in one of the preferred embodiments and can be larger in other preferred embodiments. The gap space 92 provides clearance to facilitate the placement of pretzels 20 in the pretzel mold 74 and the removal of the pretzel 20 from the pretzel mold 74 as will be described presently. The pretzel mold 74 is filled with pretzels 20 as shown in FIG. 9. After the pretzel molds 74 are filled with pretzels 20 in the manner described above, they are then ready to be stuffed or filled. It is pointed out that the pretzels 20 can be placed in the pretzel mold 74 manually or automatically. And, as previously mentioned, in another one of the preferred embodiments the pretzels 20 do contact the surrounding mold wall 82.

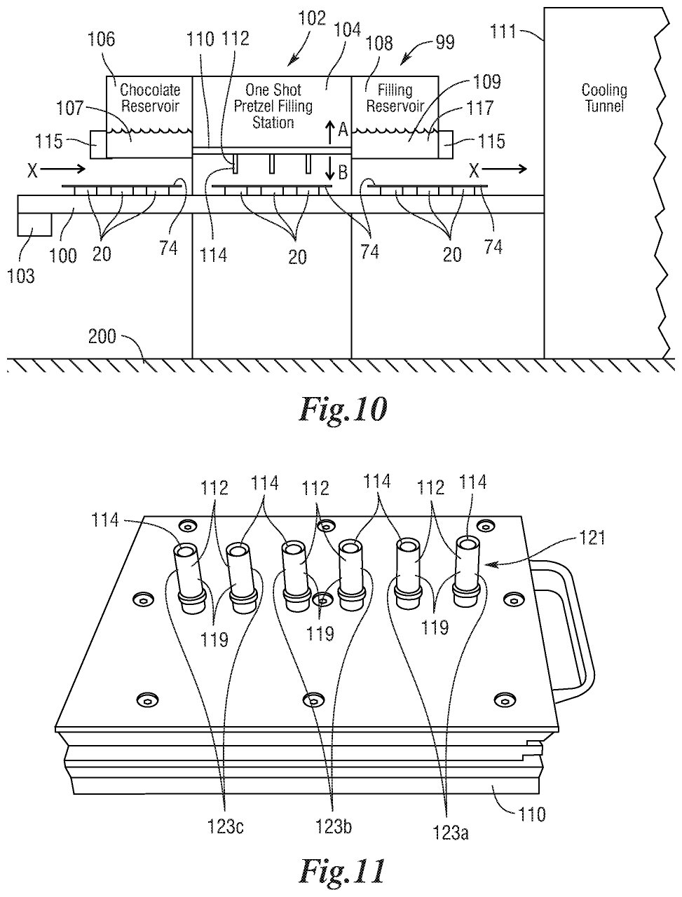

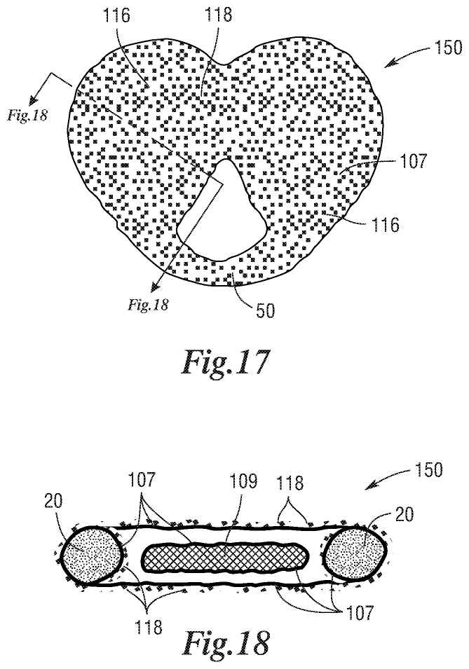

As shown in FIG. 10, there shown a first portion of an assembly line 99 for manufacturing coated stuffed pretzels 150 (shown in FIGS. 17 and 18) that includes a conveyor 100, a first work station 102, a cooling tunnel 111, a screen conveyor 101 and a chocolate coating machine 132, sometimes called a chocolate enrobing machine, or may include a chocolate bath. The pretzel molds 74, now loaded with pretzels 20, are moved onto or manually placed on the conveyor 100 that transports the pretzel molds 74 to a first workstation 102. The conveyor 100 movement is in the direction of the arrows designated X and the conveyor is driven by a motor 103. The conveyor 100 and first workstation 102 are supported on a floor 200. In operation, a pretzel mold tray 74 is moved into below a one shot filling machine 104 located at the first workstation 102. The one shot filling machine 104 has a first reservoir 106, and the first reservoir 106 is filled with chocolate 107 (milk, dark or white chocolate) that is melted and maintained at a temperature of 88.5 degrees Fahrenheit, or about 88.5 degrees Fahrenheit in other preferred embodiments. The one shot filling machine 104 has a second reservoir 108 that contains a filling 109, and in one of the preferred embodiments the filling 109 is caramel 117 that is liquid and is maintained at a temperature of 84 degrees Fahrenheit or about 84 degrees Fahrenheit. Heaters, commonly designated 115, are provided and mounted to the first and second reservoirs 106, 108 to maintain the temperature of the chocolate 107 and the caramel 117 at the above-mentioned temperatures. It is pointed out that one shot filling machines 104 are well known to those having ordinary skill in the art and are therefore it is not described in greater detail herein. One shot filling machines are commercially available from Awema AG, Schulstrasse 26, CH-8330, P Faffikon (ZH).

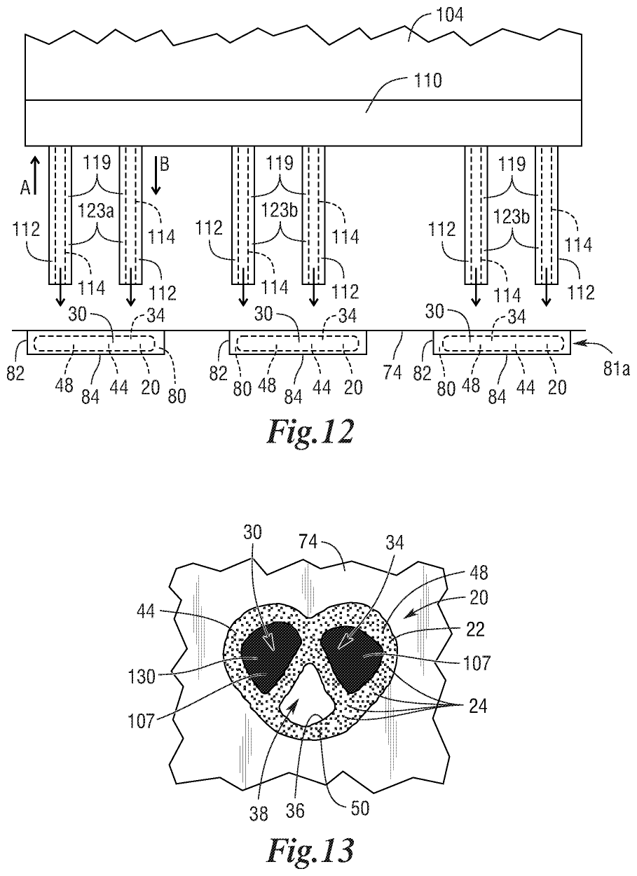

The one shot filling machine 104 also has a one-shot dispenser head 110 shown in FIGS. 10-12 that is automatically moved toward and away from the pretzel mold 74 filled with pretzels 20. This movement is indicated by the arrows designated A and B in FIGS. 10 and 12. The one shot dispenser head 110 and can also be automatically indexed over each first, second and third rows 81a, 81b, and 81c of pretzel mold recesses 80 and the pretzels 20 disposed therein. Servomotors (not shown) raise and lower the dispenser head 110 and to index the dispenser head 110 over each of the first, second and third rows 81a, 81b, and 81c (FIG. 5) of pretzel mold recesses 80 formed in the pretzel mold 74. As best shown in FIG. 11, there is a view of the one-shot dispenser head 110 that includes dispensing elements 119 with six dispensing elements 119 shown aligned in a dispensing element row 121. Each dispensing element 119 has an outer tube 112 that is for receiving the chocolate 107 delivered from the first reservoir 106. Disposed internal to each of the outer tubes 112 is an inner tube 114 (shown in FIGS. 11 and 12) that is for receiving the filling 109, for example caramel 117, delivered from the second reservoir 108. In other preferred embodiment the dispenser head 110 may be embodied with more of fewer dispensing elements 119, for example, in one preferred embodiment there are three rows of dispensing elements with each row having six dispensing elements such indexing of the one shot dispensing head would not be required, because all the pretzel mold recess, and in particular the pretzels disposed therein, could be filled simultaneously.

In operation and as shown in FIG. 12, the one-shot dispenser head 110 indexes toward the pretzel mold 74 loaded with pretzels 20 as indicated by the arrow designated B. In particular, the six dispensing elements 119 are positioned on the one shot dispenser head 110 and are arranged in first, second and third dispenser element pairs 123a, 123b, 123c. Each dispenser element 119 in each of the first, second, and third 123a, 123b, 123c is spaced from the other dispenser element 119 in the pair. One dispenser element 119 in the first dispenser element pair 123a aligns with the first opening 30 in one of the pretzels 20, and the other dispenser element 119 in the first dispense element pair 123a aligns with the second opening 34 in the pretzel 20. Similarly, one dispenser element 119 in the second dispenser element pair 123b aligns with the first opening 30 in another one of the pretzels 20, and the other dispenser element 119 in the second dispense element pair 123b aligns with the second opening 34 in another pretzel 20. And, one dispenser element 119 in the third dispenser element pair 123c aligns with the first opening 30 in another one of the pretzels 20, and the other dispenser element 119 in the third dispense element pair 123c aligns with the second opening 34 in another pretzel 20. Thus, as will be described presently three pretzels 20 and be stuffed simultaneously in this configuration.

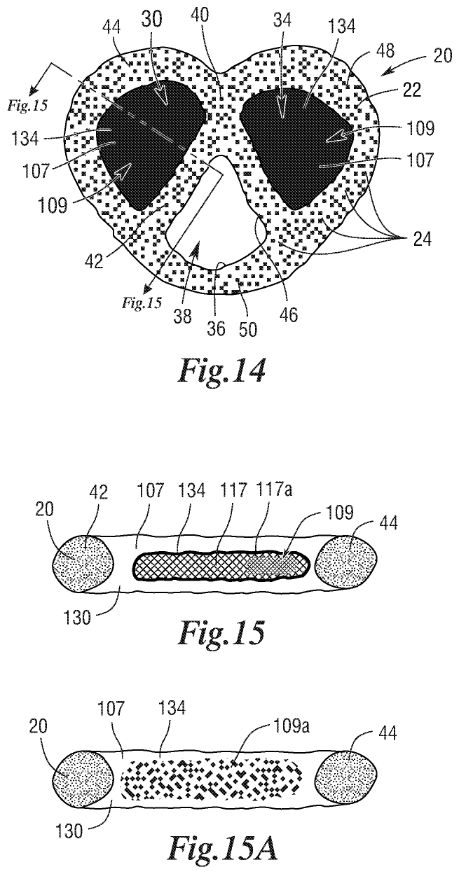

Then, the chocolate 107 flows out of the outer tubes 112 and into the first and second pretzel openings 30, 34 of each the three pretzels 20 disposed under the one shot dispenser head 110 and supported in the pretzel mold recesses 80. It is pointed out that the shot filling machine 104 has internal pistons for forcing the chocolate 107 out of the outer tubes 112 and also controls the volume of chocolate 107 dispensed. As shown in FIG. 13, this results in a layer of chocolate 130 being deposited in each of the first pretzel openings 30, and the layer of chocolate 130 is confined by the mold base wall 84 and the pretzel 20, and in particular, is confined by the mold base wall 84 and the first curved portion 44 of the pretzel 20, and the first arm portion 42 of the pretzel 20. Similarly, the layer of chocolate 130 that is deposited in the second pretzel opening 34 is confined by the mold base wall 84, the second curved portion 48 of the pretzel 20, and the second arm portion 46 of the pretzel 20. FIG. 13 shows a portion of the pretzel mold 74 after the chocolate 107 has been dispensed to create the layer of chocolate 130 that fills a portion of each of the first and second pretzel openings 30, 34. Next, chocolate 107 flows out of the outer tubes 112 and caramel 117 flows out of the inner tubes 114. When the chocolate 107 and caramel 117 flow 109 is stopped, chocolate 107 flows over the surface 117a of the caramel 117 to form a chocolate encasement layer 134 (FIGS. 14 and 15) that, together with the layer of chocolate 130 encases the caramel 117 in chocolate 107. The chocolate encasement layer 134 merges with the layer of chocolate 130 because both are melted chocolate at this point. FIG. 15 is a sectional view of the pretzel after filling and shows the caramel 117 encased in chocolate 107. At this point both of the first and second openings 30, 34 defined in the pretzels 20 are now stuffed or filled. It is pointed out that third pretzel opening 30 is not filled, and this allows for the handle portion 50 of the pretzel 20 to be used for a handle for people while consuming the coated stuffed pretzels 150.

As shown in FIGS. 11 and 12, the one-shot dispenser head 110 is capable of filling three pretzels 20 at a time, and can be indexed over the next three pretzels 20 in the pretzel mold 74, and the process repeated unit all the pretzels 20 in the pretzel mold 74 are filled in the above-described manner. In another preferred embodiment, by reconfiguring one-shot dispenser head 110 the third pretzel opening 38 can be filled in a similar manner such that not only are the first and second pretzel opening 30, 34 filled, but the third pretzel opening 38 is also filled. In another preferred embodiment only one of the first, second, and third pretzel 30, 34, 38 openings is filled in the above-described manner, and this can be accomplished by removing or repositioning the dispenser elements 119.

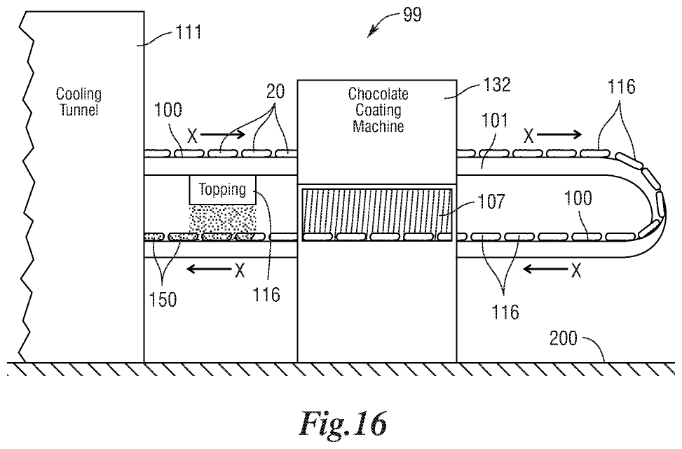

Next, as shown in FIG. 10 the conveyor 100 moves the pretzel molds 74 into a cooling tunnel 111. The air temperature in the cooling tunnel 111 is maintained at about 45 degrees Fahrenheit, or may be kept in the range of 45 to 50 degrees Fahrenheit, such that the chocolate 107 solidifies. The caramel 109 remains liquid, but it is to be understood that in other preferred embodiments the caramel can be made such that it also solidifies upon cooling. The pretzels 20 are cool and exit the cooling tunnel 111 and are removed from the pretzel molds 74 by tipping the pretzel molds 74, or completely tipping over the pretzel molds 74. The above described gap space 92 facilitates the removal process that may be done manually or automatically. The pretzels 20 are then placed on a screen conveyor 101 (FIG. 16 which is a continuation of FIG. 10) and are transported to a chocolate coating machine 132 and moved a flowing stream of chocolate 107a that entirely coats the pretzels 20 with chocolate 107. In other preferred embodiments the chocolate coating machine 132 can be replaced with a chocolate bath. The chocolate 107 used in the chocolate coating machine 132 may be milk, dark or white chocolate. As shown in FIG. 16, the screen conveyor 101 makes a one hundred eighty degree turn such that the pretzels 20 can be transported back into the cooling tunnel 111 so that the chocolate 107 from the chocolate coating machine 132 will solidify. The pretzels 20 are completely encased in chocolate 107 after exiting the chocolate coating machine 132 and now have an outer chocolate layer 116. At this point, and while the chocolate outer layer 116 is not yet solidified, toppings 118 are placed, dropped or poured on the chocolate outer layer 116. The toppings 116 can be virtually any desirable topping, for example, coconut flakes, nuts and flakes of nuts, chocolate pieces, brownie crumbles, toffee, sugars, drizzles of white chocolate or dark chocolate or more milk chocolate, sprinkles, candy pieces, chips of hard candy, salt and sea salts, and combinations thereof and without limitation. Thus, the toppings that may be added are without limitation. In other preferred embodiments no toppings 116 are used.

Then, the screen conveyor 101 is redirected into the cooling tunnel 111 where the outer chocolate layer 116 cools, and solidifies and at the same time the toppings 118 are secured or frozen in place in the outer chocolate layer 116. The pretzels 20 that began as already baked pretzels have been transformed into coated stuffed pretzels 150. FIG. 17 is a top view of the coated stuffed pretzel 150 and FIG. 18 is sectional view of the coated stuffed pretzel 150. The coated stuffed pretzels 150 are then packaged and shipped to customers. Packing is accomplished with a packaging machine (not shown) or may be packaged manually in boxes.

Thus, the ordinary pretzel 20 has been transformed into a coated stuffed pretzel 150 that is exciting when viewed and exciting to consume. This provides the consumer with an opportunity to enjoy pretzels in an entirely new and exciting way, and the consumer can hold the coated stuffed pretzel 150 from the handle portion 50 that is only coated in the outer chocolate layer 116 and toppings 118. In most instances the third pretzel opening 38 will remain at least partly open after the filling and coating processes described above have been done, thus providing a the consumer with the option of holding the coated stuffed pretzel 150 from the handle portion 50 that only has an outer chocolate layer 116. In addition and as previously mentioned, in other preferred embodiments even the third pretzel opening 38 can be filled in the manner the first and second pretzel openings 30, 34 were filled, by reconfiguring the one-shot dispenser head 110.

In another preferred embodiment only one of the first, second and third pretzel openings 30, 34, and 38 are filled in the manner described above by reconfiguring the one-shot dispenser head 110.

In addition, the shape of the already baked pretzel 20 can be variously embodied. For example, the already baked pretzel in other preferred embodiments could be circular with a single central opening that can be filled and coated in the above-described manner. Similarly, pretzels with more than three openings can be filled in the above-described manner. All such pretzels can be filled in the manner and method described herein.

In addition, in another preferred embodiment, the first and second pretzel openings 30, 34 can have different fillings, for example the first pretzel opening 30 can have caramel 117 filling, and the second pretzel opening can have peanut butter filling, or a liquid chocolate filing, a jelly filling, a marshmallow filling, a flavored chocolate filling. The types of fillings 109 that can be used are vast and virtually without limitation, and the fillings 109 can be liquid, solid, or particles. Thus, as shown in FIG. 15A, in one of the preferred embodiments the filling 109 may be in the form of pieces of filling 109a (sometimes referred to herein as particles of filling), for example pieces or particles of candy, pieces of chocolate, pieces of candy bars, pieces of nuts, without limitation, and in such embodiments the second reservoir 108 is filled with the filling that is in the form of pieces of filling 109a. In other preferred embodiments the pieces of filling 109a are mixed with a liquid filling such that the filling is a slurry of liquid filling, for example caramel 117 and pieces of filling 109a. All such embodiments come within the scope and spirit of the coated stuffed pretzel 150.

In addition, the coated stuffed pretzel 150 is provides for an improved culinary experience as compared to the hard baked pretzels, and hard baked pretzels with dry fillings. Indeed, the coated stuffed pretzel 150 retains the crunch of the pretzel 20, while at the same time provides for delicious fillings 109 and chocolate 107 and toppings 118 and an amazing culinary experience.

It will be appreciated by those skilled in the art that while the coated stuffed pretzel 150 and method for making the coated stuffed pretzel 150 have been described in detail herein, the invention is not necessarily so limited and other examples, embodiments, uses, modifications, and departures from the embodiments, examples, uses, and modifications may be made without departing from the coated stuffed pretzel 150 and the method for making the coated stuffed pretzel 150 and all such embodiments are intended to be within the scope and spirit of the appended claims.

What is claimed is:

1. A coated stuffed pretzel consisting of:
a pretzel that has already been baked and the pretzel having a first surrounding pretzel wall that defines a first pretzel opening;
chocolate and a filing and the first pretzel opening is stuffed with the chocolate and filing and the chocolate encases the filling;
an outer layer of chocolate that encases the entire pretzel including the chocolate that encases the filling positioned in the first pretzel opening.

2. A coated stuffed pretzel consisting of:
a) a first surrounding pretzel wall that defines a first pretzel opening and a second surrounding pretzel wall that defines a second pretzel opening, and the pretzel has a third surrounding wall that defines a third pretzel opening;
b) a cross portion from which extends a first arm portion and a first curved portion, and the first arm portion extends to and merges with the first curved portion at a first junction portion, and a second arm portion and a second curved portion extend from the cross portion, and the second arm portion extends to and merges with the second curved portion at a second junction portion;
c) a handle portion that extends to and merges with the first junction portion and the handle portion extends to and merges with the second junction portion;
d) the first pretzel opening is stuffed with chocolate and filing and the second pretzel opening is stuffed with chocolate and filing such that chocolate encases the filling; and,
e) an outer layer of chocolate encases the chocolate that encases the filling located in the first and second pretzel openings, and wherein the outer layer of chocolate encases the handle portion in chocolate.

3. A coated stuffed pretzel consisting of:
a) a first surrounding pretzel wall that defines a first pretzel opening and a second surrounding pretzel wall that defines a second pretzel opening, and the pretzel has a third surrounding wall that defines a third pretzel opening;
b) a cross portion from which extends a first arm portion and a first curved portion, and the first arm portion extends to and merges with the first curved portion at a first junction portion, and a second arm portion and a second curved portion extend from the cross portion, and the second arm portion extends to and merges with the second curved portion at a second junction portion;
c) a handle portion that extends to and merges with the first junction portion and the handle portion extends to and merges with the second junction portion;
d) the first pretzel opening is stuffed with chocolate and filling and the second pretzel opening is stuffed with chocolate and filling such that chocolate encases the filling;
e) an outer layer of chocolate encases the chocolate that encases the filling located in the first and second pretzel openings, and wherein the outer layer of chocolate encases the handle portion in chocolate; and,
f) toppings that are embodied in the outer chocolate layer.
